(19) United States
(12) Patent Application Publication
(10) Pub. No.: US 2024/0394762 A1
(43) Pub. Date: Nov. 28, 2024

(54) RESIDUAL PULSE COST CALCULATION METHOD AND PROCESSOR

(71) Applicant: Gigaphoton Inc., Tochigi (JP)

(72) Inventor: Yuji MINEGISHI, Oyama-shi (JP)

(73) Assignee: Gigaphoton Inc., Tochigi (JP)

(21) Appl. No.: 18/797,560

(22) Filed: Aug. 8, 2024

Related U.S. Application Data
(63) Continuation of application No. PCT/JP2022/012635, filed on Mar. 18, 2022.

(51) Int. Cl. G06Q 30/0283

(52) U.S. Cl. CPC G06Q 30/0283

(57) ABSTRACT

A residual pulse cost calculation method for a component of a light source which outputs a pulse laser beam includes, by a processor, acquiring first data in which the component of the light source and an operation pulse count of the component sequentially stored through an operation of the light source are associated with each other, acquiring second data in which the component and a standard guaranteed pulse count of the component are associated with each other, acquiring third data in which the light source and a pulse unit price of the light source are associated with each other, calculating a residual pulse count of the component from the operation pulse count and the standard guaranteed pulse count, calculating a residual pulse cost of the component from the residual pulse count and the pulse unit price, and outputting the residual pulse cost.

### CROSS-REFERENCE TO RELATED APPLICATIONS

The present application is a continuation application of International Application No. PCT/JP2022/012635, filed on Mar. 18, 2022, the entire contents of which are hereby incorporated by reference.

### BACKGROUND

### 1. Technical Field

The present disclosure relates to a residual pulse cost calculation method and a processor.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 pm to 400 pm. Therefore, when a projection lens is formed of a material that transmits ultraviolet light such as a KrF laser beam and an ArF laser beam, chromatic aberration may occur. As a result, the resolution may decrease. Given this, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (etalon or grating, etc.) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: Japanese Unexamined Patent Application Publication No. 2003-99119

Patent Document 2: Japanese Unexamined Patent Application Publication No. 2013-179109

### SUMMARY

A residual pulse cost calculation method according to an aspect of the present disclosure is a residual pulse cost calculation method for a component of a light source which outputs a pulse laser beam, and includes, by a processor, acquiring first data in which the component of the light source and an operation pulse count of the component sequentially stored through an operation of the light source are associated with each other, acquiring second data in which the component and a standard guaranteed pulse count of the component are associated with each other, acquiring third data in which the light source and a pulse unit price of the light source are associated with each other, calculating a residual pulse count of the component from the operation pulse count and the standard guaranteed pulse count, calculating a residual pulse cost of the component from the residual pulse count and the pulse unit price, and outputting the residual pulse cost.

A processor according to another aspect of the present disclosure is a processor that calculates a residual pulse cost of a component of a light source which outputs a pulse laser beam, and includes a data acquisition unit, a residual pulse cost calculation unit, and an output unit. The data acquisition unit is configured to acquire first data in which the component of the light source and an operation pulse count of the component sequentially stored through an operation of the light source are associated with each other, second data in which the component and a standard guaranteed pulse count of the component are associated with each other, and third data in which the light source and a pulse unit price of the light source are associated with each other. The residual pulse cost calculation unit is configured to calculate a residual pulse count of the component from the operation pulse count and the standard guaranteed pulse count and calculate a residual pulse cost of the component from the residual pulse count and the pulse unit price. The output unit is configured to output the residual pulse cost.

A residual pulse cost calculation method according to a further aspect of the present disclosure is a residual pulse cost calculation method for a component of a light source which outputs a pulse laser beam, and includes, by a processor, acquiring first data in which the component of the light source and an operation pulse count of the component sequentially stored through an operation of the light source are associated with each other, acquiring second data in which the component and a standard guaranteed pulse count of the component are associated with each other, acquiring third data in which the light source and a pulse unit price of the light source are associated with each other, acquiring a date indicating a scheduled replacement date of the component, calculating a predictive value of the operation pulse count of the component on the date from a change with time of the operation pulse count, calculating a predictive value of the residual pulse count of the component from the predictive value of the operation pulse count and the standard guaranteed pulse count, calculating a predictive value of a residual pulse cost of the component from the predictive value of the residual pulse count and the pulse unit price, and outputting the predictive value of the residual pulse cost.

A processor according to a still further aspect of the present disclosure is a processor that calculates a residual pulse cost of a component of a light source which outputs a pulse laser beam, and includes a data acquisition unit, an information input unit, a residual pulse cost calculation unit, and an output unit. The data acquisition unit is configured to acquire first data in which the component of the light source and an operation pulse count of the component sequentially stored through an operation of the light source are associated with each other, second data in which the component and a standard guaranteed pulse count of the component are associated with each other, and third data in which the light source and a pulse unit price of the light source are associated with each other. The information input unit is configured to acquire a date indicating a scheduled replacement date of the component. The residual pulse cost calculation unit is configured to calculate a predictive value of the operation pulse count on the date from a change with time of the operation pulse count, calculate a predictive value of the residual pulse count of the component from the predictive value of the operation pulse count and the standard guaranteed pulse count, and calculate a predictive value of the residual pulse cost of the component from the predictive value of the residual pulse count and the pulse unit price. The output unit is configured to output the predictive value of the residual pulse cost.

### BRIEF DESCRIPTION OF THE DRAWINGS

Some embodiments of the present disclosure will be described below, by way of example only, with reference to the accompanying drawings.

FIG. 1 schematically illustrates a configuration of a light source management system according to a comparative example.

FIG. 2 is a flowchart illustrating an example of processing executed by a processor of the comparative example.

FIG. 3 is a table illustrating an example of operation data acquired by a data acquisition unit.

FIG. 4 is a table illustrating an example of data of a standard guaranteed pulse count acquired by the data acquisition unit.

FIG. 5 is a table illustrating an output example of an optimum replacement date.

FIG. 6 is a flowchart illustrating an example of a subroutine applied to step S4 in FIG. 2.

FIG. 7 is a graph illustrating a creation example of an approximate straight line of an operation pulse count of a component 11, and an example of a method of obtaining an optimum replacement date from a predictive straight line obtained by extrapolating the approximate straight line and a standard guaranteed pulse count.

FIG. 8 schematically illustrates a configuration of a light source management system according to an embodiment 1.

FIG. 9 is a flowchart illustrating an example of processing executed by a processor according to the embodiment 1.

FIG. 10 is a table illustrating an example of contract data acquired by a data acquisition unit.

FIG. 11 is a table illustrating a display example of a residual pulse cost.

FIG. 12 is a flowchart illustrating an example of a subroutine applied to step S25 in FIG. 9.

FIG. 13 is a flowchart illustrating an example of processing executed by a processor according to a modification 1 of the embodiment 1.

FIG. 14 is a table illustrating an example of contract data acquired by a data acquisition unit.

FIG. 15 is a flowchart illustrating an example of a subroutine applied to step S25B in FIG. 13.

FIG. 16 is a flowchart illustrating an example of processing executed by a processor according to a modification 2 of the embodiment 1.

FIG. 17 is a flowchart illustrating an example of a subroutine applied to step S25C in FIG. 16.

FIG. 18 is a graph illustrating an example of calculating a standard guaranteed pulse count based on an average value of pulse energy of a light source.

FIG. 19 schematically illustrates a configuration of a light source management system according to an embodiment 2.

FIG. 20 is a flowchart illustrating an example of processing executed by a processor according to the embodiment 2.

FIG. 21 is a table illustrating a display example of a predictive value of a residual pulse cost.

FIG. 22 is a flowchart illustrating an example of a subroutine applied to step S55 in FIG. 20.

FIG. 23 is a graph illustrating a creation example of an approximate straight line of an operation pulse count of a component, and an example of a method of obtaining a predictive value of an operation pulse count on a future date from a predictive straight line obtained by extrapolating the approximate straight line.

FIG. 24 is a flowchart illustrating an example of processing executed by a processor according to a modification 1 of the embodiment 2.

FIG. 25 is a flowchart illustrating an example of a subroutine applied to step S55B in FIG. 24.

FIG. 26 is a flowchart illustrating an example of processing executed by a processor according to a modification 2 of the embodiment 2.

FIG. 27 is a flowchart illustrating an example of a subroutine applied to step S55C in FIG. 26.

FIG. 28 schematically illustrates a configuration of a light source management system according to a modification 3 of the embodiment 2.

FIG. 29 is a flowchart illustrating an example of processing executed by a processor according to the modification 3 of the embodiment 2.

FIG. 30 is a table illustrating an example of operation data acquired by a data acquisition unit.

FIG. 31 is a table illustrating an example of data of a standard guaranteed pulse count acquired by a data acquisition unit.

FIG. 32 is a table illustrating an example of contract data acquired by a data acquisition unit.

FIG. 33 is a table illustrating a display example of a predictive value of a residual pulse cost.

FIG. 34 is a flowchart illustrating an example of a subroutine applied to step S84 in FIG. 29.

### DESCRIPTION OF EMBODIMENTS

### Table of Content

1. Outline of Light Source Management System according to Comparative Example
   1.1 Configuration
   1.2 Operation
   1.3 Problem
2. Embodiment 1
   2.1 Configuration
   2.2 Operation
   2.3 Effect
   2.4 Modification 1
      2.4.1 Configuration
      2.4.2 Operation
      2.4.3 Effect
   2.5 Modification 2
      2.5.1 Configuration
      2.5.2 Operation
      2.5.3 Effect
3. Embodiment 2
   3.1 Configuration
   3.2 Operation
   3.3 Effect
   3.4 Modification 1
      3.4.1 Configuration
      3.4.2 Operation
      3.4.3 Effect
   3.5 Modification 2
      3.5.1 Configuration
      3.5.2 Operation
      3.5.3 Effect
   3.6 Modification 3
      3.6.1 Configuration
      3.6.2 Operation
      3.6.3 Effect
4. Program for Realizing Processing Functions of Processor 20
5. Others

Hereinafter, embodiments of the present disclosure will be described in detail with reference to the drawings. The embodiments described below show some examples of the present disclosure and do not limit contents of the present disclosure. In addition, all configurations and operations described in the embodiments are not necessarily essential as configurations and operations of the present disclosure. Here, the same components are denoted by the same reference numerals, and any redundant description thereof is omitted.

### 1. Outline of Light Source Management System according to Comparative Example

### 1.1 Configuration

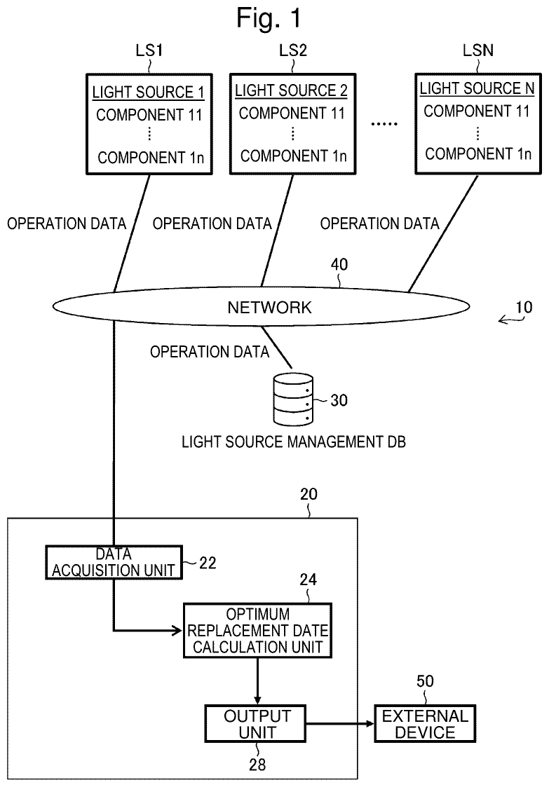

FIG. 1 schematically illustrates a configuration of a light source management system 10 according to a comparative example. The comparative example of the present disclosure is an example recognized by the applicant as known only by the applicant, and is not a publicly known example admitted by the applicant. The light source management system 10 includes a plurality of light sources LS1, LS2, . . . LSN which output a pulse laser beam, a processor 20, and a light source management database (DB) 30. The plurality of light sources LSk (k=1, 2, . . . N) may be, for example, all light source devices in a semiconductor plant. Each light source LSk may be, for example, an excimer laser apparatus. Each light source LSk includes a plurality of components. In the present specification and the drawings, for n pieces of components, the individual components are distinguished by using component numbers “1j” including an index number j, and are expressed as “component 11”, “component 12”, . . . “component 1n”.

The processor 20 is a processing device including an unillustrated CPU (Central Processing Unit) and a memory. The processor 20 may include a GPU (Graphics Processing Unit). The processor 20 is specifically configured or programmed to perform various kinds of processing included in the present disclosure. The processor 20 includes a data acquisition unit 22, an optimum replacement date calculation unit 24, and an output unit 28. The data acquisition unit 22 reads data from the light source management DB 30, and transmits the read data to the optimum replacement date calculation unit 24. The data acquisition unit 22 is a terminal device or a radio communication apparatus connected to a network 40, and a serial interface or a LAN (Local Area Network) interface connected thereto.

The optimum replacement date calculation unit 24 is, for example, a CPU. The output unit 28 outputs a calculation result in the optimum replacement date calculation unit 24 to an external device 50. The output unit 28 is, for example, a serial interface or a LAN interface. In addition, the output unit 28 may output the calculation result to an LCD (Liquid Crystal Display) or an organic EL display in the processor 20.

The external device 50 may be, for example, a display device such as an LCD or an organic EL display, a user management server, or a management server of a light source manufacturer.

The light source management DB 30 may be disposed in a semiconductor plant or in a light source manufacturer. Alternatively, the light source management DB 30 may be disposed in the processor 20.

The light sources LSk, the processor 20, and the light source management DB 30 are connected to each other via the network 40. The network 40 is a communication line capable of transmitting information by a wire, radio, or a combination thereof. The network 40 may be a wide area network or a local area network.

### 1.2 Operation

In the light source management DB 30, respective light source numbers, models, and operation data are input from the light sources LSk in association with a date and stored. The light source number is an intrinsic identification number uniquely defined for each light source LSk. The light source number may be a serial number of each light source LSk. The operation data includes information such as pulse energy, an operation pulse count of the light source, and an operation pulse count of each component. A value of the operation pulse count of each component is reset when the component is replaced, and counting of the operation pulse count is newly started after the component is replaced. The operation pulse count of a component may be one of indexes for determining a degradation degree of each component for components having different replacement times.

The operation data of each light source LSk is sequentially input to the light source management DB 30 and stored. With an operation of the light sources LSk, the operation data is added to the light source management DB 30 every day, and the data is accumulated. In addition, the light source management DB 30 stores data of a standard guaranteed pulse count of each component. The standard guaranteed pulse count is a pulse count that can be guaranteed by the pulse energy used.

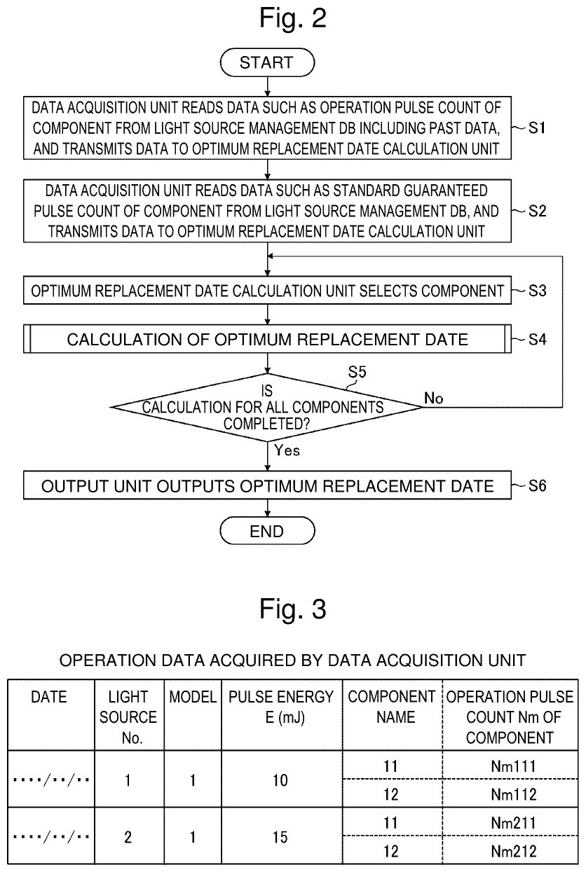

The processor 20 calculates and outputs an optimum replacement date of each component. This calculation flow is illustrated in FIG. 2.

When a flowchart in FIG. 2 is started, in step S1, the data acquisition unit 22 reads data such as the operation pulse count of the component from the light source management DB 30 including past data, and transmits the read data to the optimum replacement date calculation unit 24. FIG. 3 illustrates an example of the operation data acquired by the data acquisition unit 22 from the light source management DB 30. While FIG. 3 illustrates only two components having component numbers “11” and “12” regarding an entry of a component name, two or more components may be actually present. The same applies to other figures such as FIG. 5.

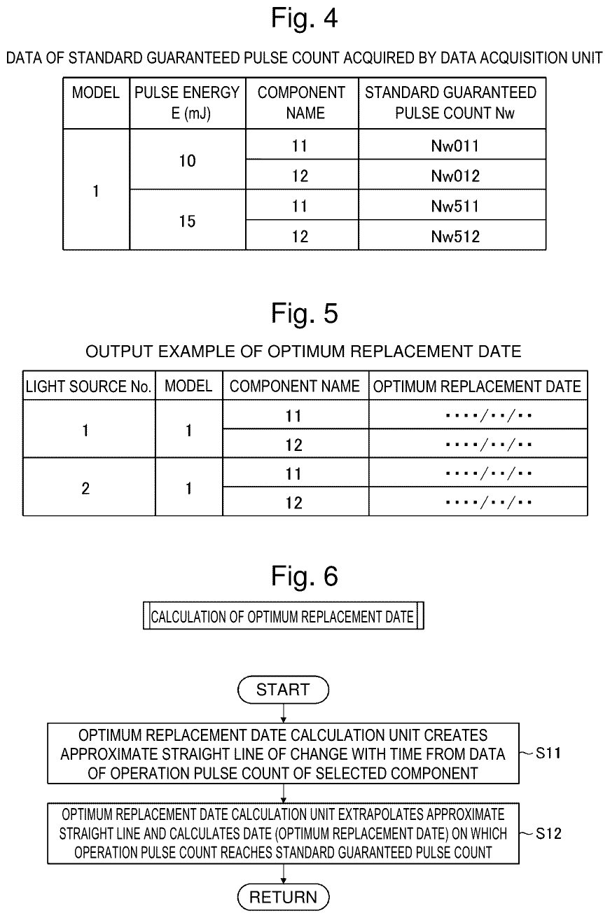

In step S2, the data acquisition unit 22 reads data such as the standard guaranteed pulse count of the component from the light source management DB 30, and transmits the read data to the optimum replacement date calculation unit 24. FIG. 4 illustrates an example of the data of the standard guaranteed pulse count acquired by the data acquisition unit 22 from the light source management DB 30.

In step S3, the optimum replacement date calculation unit 24 selects a component for which the optimum replacement date is to be calculated.

In step S4, the optimum replacement date calculation unit 24 executes a calculation subroutine for the optimum replacement date. The subroutine applied in step S4 will be described later (FIG. 6).

After step S4, in step S5, the optimum replacement date calculation unit 24 determines whether or not the optimum replacement dates of all the components have been calculated. When a determination result in step S5 is No determination, the optimum replacement date calculation unit 24 returns to step S3. The optimum replacement date calculation unit 24 repeats steps S3 to S5 until calculation of the optimum replacement dates of all the components is completed.

When the determination result in step S5 is Yes determination, the flow proceeds to step S6. In step S6, the output unit 28 outputs the optimum replacement date. Here, “outputting” includes concepts of outputting to the output unit 28 of the processor 20, notifying a service engineer (FSE) or the like, and notifying a user. After step S6, the flowchart in FIG. 2 is ended. The optimum replacement date may be calculated daily or once every few days.

FIG. 5 illustrates an output example when the optimum replacement date is output to a display unit or the like of the processor 20. A service engineer or the like confirms the optimum replacement date of each component and replaces each component before the optimum replacement date.

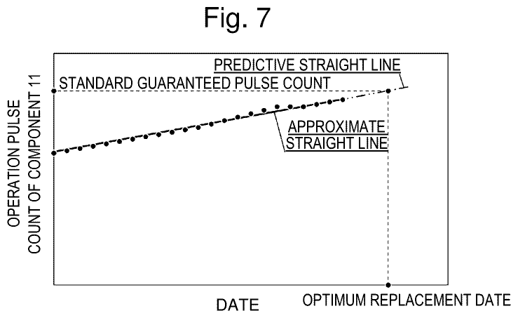

FIG. 6 is a flowchart illustrating an example of a subroutine applied in step S4 in FIG. 2. When the flowchart in FIG. 6 is started, in step S11, the optimum replacement date calculation unit 24 creates an approximate straight line of a change with time from the data of the operation pulse count of a selected component. FIG. 7 illustrates a creation example of an approximate straight line of the operation pulse count of the component 11 of the light source LS1. Note that approximation may be curve approximation.

In step S12, the optimum replacement date calculation unit 24 extrapolates the approximate straight line and calculates a date (optimum replacement date) on which the operation pulse count reaches the standard guaranteed pulse count. As illustrated in FIG. 7, the optimum replacement date of the component 11 of the light source LS1 is obtained from a predictive straight line obtained by extrapolating the approximate straight line and the standard guaranteed pulse count. For example, if a graph in FIG. 7 is obtained when the pulse energy of the light source LS1 is fixed (for example, 10 mJ), the standard guaranteed pulse count of the component 11 of the light source LS1 is Nw011 from a table in FIG. 4.

After step S12, the flowchart in FIG. 6 is ended and the flow returns to the flowchart in FIG. 2.

### 1.3 Problem

It is appropriate to replace a component on the optimum replacement date, however, a user sometimes requests component replacement (early component replacement) earlier than the optimum replacement date in consideration of safety in order to prevent unplanned down. The early component replacement is a loss of a light source manufacturer in terms of business, and it is important to calculate and recognize the loss (cost) in advance.

### 2. Embodiment 1

### 2.1 Configuration

An embodiment 1 provides a method of calculating a loss (cost) when a component is replaced early in a case where a light source manufacturer is under a contract for a pulse unit price of the light source LSk with a user. Here, the contract for the pulse unit price of the light source LSk is a kind of meter rate charging, and is to periodically pay a charge according to a used pulse count of the light source LSk, instead of paying a price for periodic component replacement or periodic maintenance by a service engineer (FSE) required to stably operate the light source LSk whenever it occurs. This contract includes the required periodic component replacement and periodic maintenance by a service engineer. Further, the pulse unit price refers to a cost per unit pulse count of the light source.

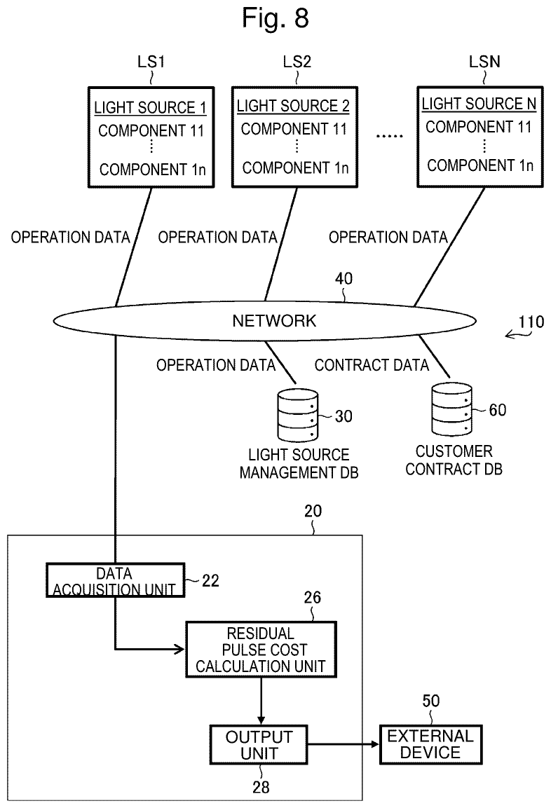

FIG. 8 schematically illustrates a configuration of a light source management system 110 according to the embodiment 1. A difference from FIG. 1 will be described with respect to FIG. 8. The light source management system 110 differs from the configuration of FIG. 1 in that it includes a customer contract database (DB) 60. In addition, the light source management system 110 differs in that the processor 20 includes a residual pulse cost calculation unit 26. Other configurations may be similar to those in FIG. 1. The customer contract DB 60 may be disposed in a semiconductor plant or in a light source manufacturer. Alternatively, the customer contract DB 60 may be disposed in the processor 20. The customer contract DB 60 and the processor 20 are connected via the network 40.

### 2.2 Operation

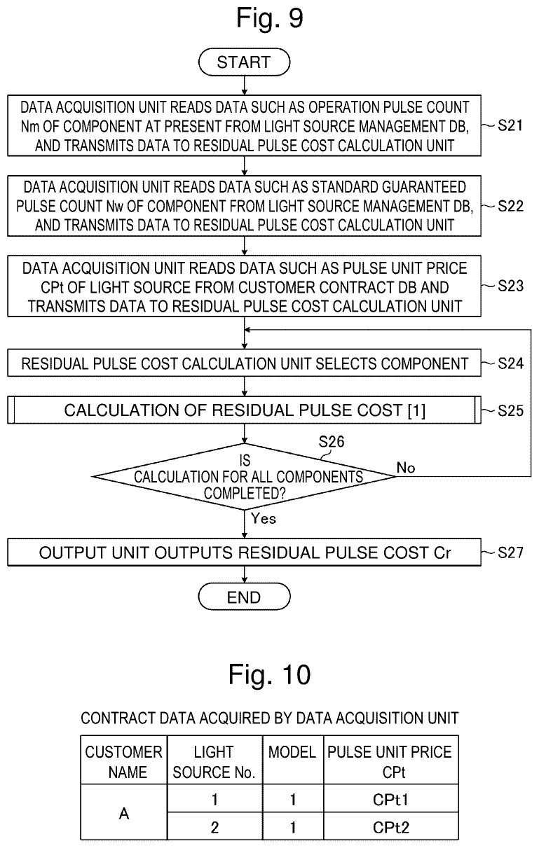

In the customer contract DB 60, contract data such as a price of each light source LSk, the pulse unit price, and a price of each component is input and stored in association with a customer name, the light source number, and the model. The processor 20 calculates a residual pulse cost of each component based on the operation data of each component and the contract data, and outputs a calculation result. The calculation flow is illustrated in FIG. 9.

When the flowchart in FIG. 9 is started, in step S21, the data acquisition unit 22 reads data such as an operation pulse count Nm (see FIG. 3) of the component at present from the light source management DB 30, and transmits the data to the residual pulse cost calculation unit 26. In the embodiment 1, it is assumed that the pulse energy as an operating condition of the light source LSk is fixed (for example, 10 mJ). The data of the operation pulse count Nm of each component stored in association with the date illustrated in FIG. 3 is an example of “an operation pulse count of a component that is sequentially stored” in the present disclosure. The data illustrated in FIG. 3 is an example of “first data” in the present disclosure. In addition, the operation pulse count Nm of the component at present is an example of “an operation pulse count on a latest date” in the present disclosure.

In step S22, the data acquisition unit 22 reads data such as a standard guaranteed pulse count Nw (see FIG. 4) of the component from the light source management DB 30, and transmits the data to the residual pulse cost calculation unit 26. The data illustrated in FIG. 4 is an example of “second data” in the present disclosure.

In step S23, the data acquisition unit 22 reads data such as a pulse unit price CPt (see FIG. 10) of the light source LSk from the customer contract DB 60, and transmits the data to the residual pulse cost calculation unit 26. FIG. 10 illustrates an example of contract data acquired by the data acquisition unit 22 from the customer contract DB 60. The pulse unit price CPt is set for the light source LSk of each customer. The contract data illustrated in FIG. 10 is an example of “third data” in the present disclosure.

In step S24, the residual pulse cost calculation unit 26 selects a component for which the residual pulse cost is to be calculated.

In step S25, the residual pulse cost calculation unit 26 executes a subroutine of calculation [1] of the residual pulse cost. An example of the subroutine applied in step S25 will be described later (FIG. 12).

After step S25, in step S26, the residual pulse cost calculation unit 26 determines whether or not the residual pulse costs of all the components have been calculated. When a determination result in step S26 is No determination, the residual pulse cost calculation unit 26 returns to step S24. The residual pulse cost calculation unit 26 repeats steps S24 to S26 until the calculation of the residual pulse costs of all the components is completed.

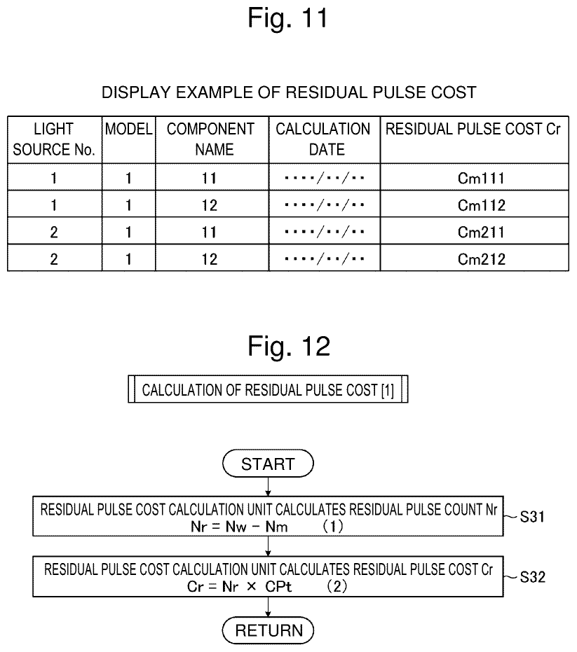

When the determination result in step S26 is Yes determination, the flow proceeds to step S27. In step S27, the output unit 28 outputs a residual pulse cost Cr. Here, “outputting” includes at least one of transmitting a calculation result to a display unit of the processor 20 and transmitting the calculation result to a display unit on the network 40 via the data acquisition unit 22. FIG. 11 illustrates a display example when the calculation result of the residual pulse cost is displayed on the display unit of the processor 20 or the like. This residual pulse cost may be calculated daily or once every few days.

After step S27, the processor 20 ends the flowchart in FIG. 9.

FIG. 12 is a flowchart illustrating an example of the subroutine applied in step S25 in FIG. 9. When the flowchart in FIG. 12 is started, in step S31, the residual pulse cost calculation unit 26 calculates a residual pulse count Nr according to Equation (1).

$$\\ \begin{matrix}Nr = Nw - Nm & ( 1 )\end{matrix}$$

In step S32, the residual pulse cost calculation unit 26 calculates the residual pulse cost Cr by Equation (2).

$$\\ \begin{matrix}Cr = Nr \times CPt & ( 2 )\end{matrix}$$

After step S32, the flowchart in FIG. 12 is ended and the flow returns to the flowchart in FIG. 9.

### 2.3 Effect

According to the residual pulse cost calculation method executed by the processor 20 according to the embodiment 1, it is possible to recognize the loss (cost) in the case of early component replacement.

### 2.4 Modification 1

### 2.4.1 Configuration

A configuration of the light source management system 110 according to a modification 1 of the embodiment 1 may be the same as that of FIG. 8. As compared with the embodiment 1, the contract data acquired by the data acquisition unit 22 from the customer contract DB 60 is different in the modification 1. Further, a calculation formula of the residual pulse cost in the residual pulse cost calculation unit 26 is different. In the modification 1 of the embodiment 1, the residual pulse cost is calculated by considering a price ratio of the component to the price of the light source LSk.

### 2.4.2 Operation

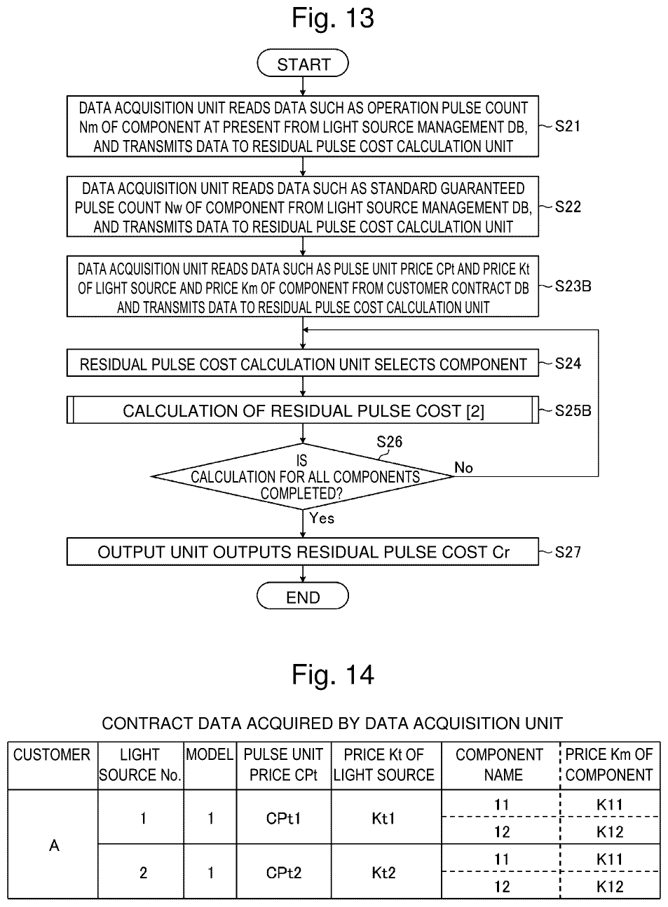

FIG. 13 is a calculation flow executed by the processor 20 according to the modification 1 of the embodiment 1. The flowchart in FIG. 13 will be described in terms of differences from that in FIG. 9.

The flowchart in FIG. 13 includes step S23B instead of step S23 in FIG. 9, and includes step S25B instead of step S25. The other steps may be similar to those in FIG. 9.

In step S23B, the data acquisition unit 22 reads data such as the pulse unit price CPt and a price Kt of the light source and a price Km of the component from the customer contract DB 60, and transmits the data to the residual pulse cost calculation unit 26. FIG. 14 illustrates an example of contract data acquired by the data acquisition unit 22 from the customer contract DB 60. Data in which the light source number and the price Kt of the light source are associated with each other in the contract data illustrated in FIG. 14 is an example of “fourth data” in the present disclosure. Further, Data in which the component and the price Km of the component are associated with each other is an example of “fifth data” in the present disclosure.

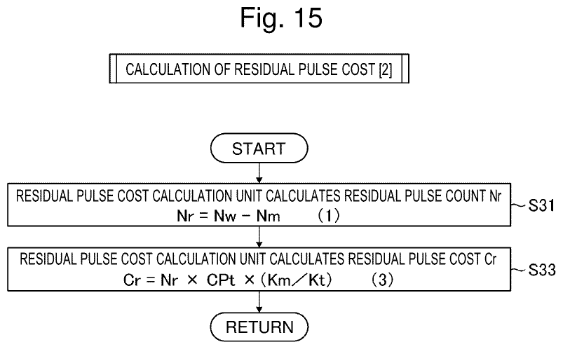

In step S25B, the residual pulse cost calculation unit 26 executes a subroutine of calculation [2] of the residual pulse cost. The subroutine is illustrated in FIG. 15.

The flowchart illustrated in FIG. 15 will be described in terms of differences from that in FIG. 12. The flowchart in FIG. 15 includes step S33 instead of step S32 in FIG. 12. The other steps may be similar to those in FIG. 12.

After step S31, in step S33, the residual pulse cost calculation unit 26 calculates the residual pulse cost Cr by Equation (3).

$$\\ \begin{matrix}Cr = Nr \times CPt \times ( Km / Kt ) & ( 3 )\end{matrix}$$

After step S33, the flowchart in FIG. 15 is ended, and the flow returns to the flowchart in FIG. 13.

### 2.4.3 Effect

According to the modification 1 of the embodiment 1, the same effects as those of the embodiment 1 can be obtained. Further, according to the modification 1 of the embodiment 1, the residual pulse cost of the component is calculated using a value obtained by converting the pulse unit price CPt of the light source into the pulse unit price of the component. Therefore, it is possible to more appropriately recognize a difference in loss depending on the component.

### 2.5 Modification 2

### 2.5.1 Configuration

The standard guaranteed pulse count varies depending on operating conditions such as pulse energy, power, and a spectral linewidth of the pulse laser beam output from the light source LSk. For example, when the pulse energy (mJ) of the pulse laser beam output from the light source is high, the standard guaranteed pulse count is small. In addition, the standard guaranteed pulse count also varies depending on the power (W) of the pulse laser beam output from the light source.

In a modification 2 of the embodiment 1, a residual pulse cost calculation method considering the pulse energy, which is one of the operating conditions of the light source, will be described.

A configuration of the light source management system 110 according to the modification 2 of the embodiment 1 may be the same as that in FIG. 8. As compared with the embodiment 1, in the modification 2, the standard guaranteed pulse count used in the calculation of the residual pulse cost in the residual pulse cost calculation unit 26 is different.

### 2.5.2 Operation

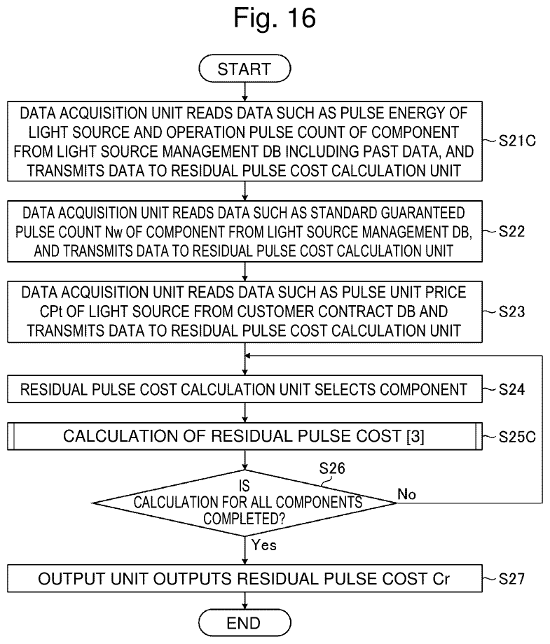

FIG. 16 is a calculation flow executed by the processor 20 according to the modification 2 of the embodiment 1. The flowchart in FIG. 16 will be described in terms of differences from that in FIG. 9.

The flowchart in FIG. 16 includes step S21C instead of step S21 in FIG. 9, and includes step S25C instead of step S25. The other steps may be similar to those in FIG. 9.

In step S21C, the data acquisition unit 22 reads data such as the pulse energy of the light source LSk and the operation pulse count of the component from the light source management DB 30 including the past data, and transmits the data to the residual pulse cost calculation unit 26. Data in which the light source number and the pulse energy included in the operation data illustrated in FIG. 3 are associated with each other is an example of “sixth data” in the present disclosure.

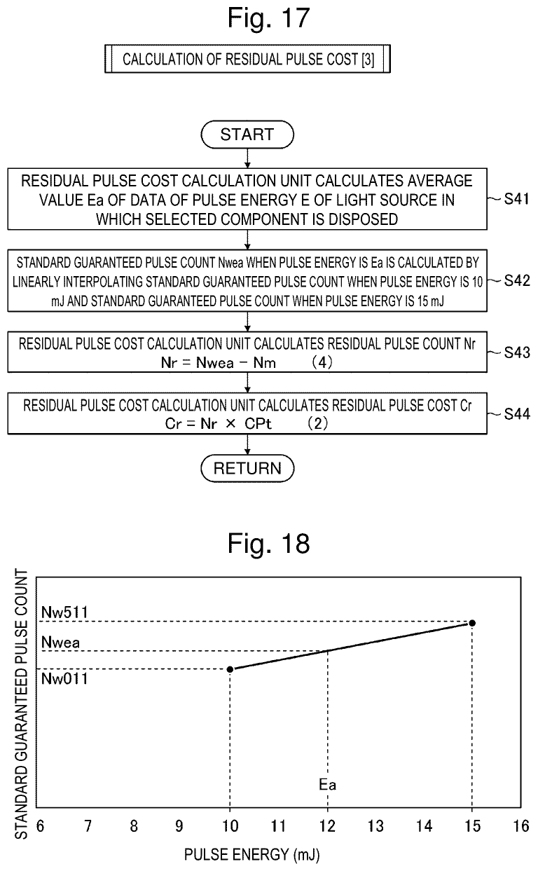

In step S25C, the residual pulse cost calculation unit 26 executes a subroutine of calculation [3] of the residual pulse cost. The subroutine is illustrated in FIG. 17. Here, a case where an operation in which the pulse energy of the pulse laser beam output from the light source LSk is 10 mJ and an operation in which the pulse energy is 15 mJ are mixed will be described as an example.

When the flowchart in FIG. 17 is started, in step S41, the residual pulse cost calculation unit 26 calculates an average value Ea of the data of the pulse energy E of the light source in which the selected component is disposed.

In step S42, the residual pulse cost calculation unit 26 calculates a standard guaranteed pulse count Nwea when the pulse energy is Ea by linear interpolation between the standard guaranteed pulse count when the pulse energy is 10 mJ and the standard guaranteed pulse count when the pulse energy is 15 mJ. The residual pulse cost calculation unit 26 performs an interpolating operation based on the data of the standard guaranteed pulse count described with reference to FIG. 4, for example. FIG. 18 illustrates a calculation example of the standard guaranteed pulse count Nwea when the average value Ea of the pulse energy of the light source LS1 in which the component 11 is disposed is 12 mJ.

In FIG. 18, the standard guaranteed pulse count Nwea when the pulse energy is 12 mJ is calculated by linear interpolation between a standard guaranteed pulse count Nw011 when the pulse energy is 10 mJ and a standard guaranteed pulse count Nw511 when the pulse energy is 15 mJ. The standard guaranteed pulse count Nwea may be calculated by curve interpolation or may be calculated from the data of three or more standard guaranteed pulse counts.

The “10 mJ” illustrated in FIG. 4 and FIG. 18 is an example of “first pulse energy” in the present disclosure, and the “standard guaranteed pulse count Nw011” is an example of “first standard guaranteed pulse count” in the present disclosure. Further, the “15 mJ” is an example of “second pulse energy” in the present disclosure, and the “standard guaranteed pulse count Nw511” is an example of “second standard guaranteed pulse count” in the present disclosure. The average value Ea of the pulse energy is an example of “energy average value” in the present disclosure, and the standard guaranteed pulse count Nwea is an example of “third standard guaranteed pulse count” in the present disclosure.

In step S43 after step S42, the residual pulse cost calculation unit 26 calculates the residual pulse count Nr according to Equation (4).

$$\\ \begin{matrix}Nr = Nwea - Nm & ( 4 )\end{matrix}$$

In step S44, the residual pulse cost calculation unit 26 calculates the residual pulse cost Cr by Equation (2).

After step S44, the flowchart in FIG. 17 is ended, and the flow returns to the flowchart in FIG. 16.

### 2.5.3 Effect

According to the modification 2 of the embodiment 1, the same effects as those of the embodiment 1 can be obtained. Further, according to the modification 2 of the embodiment 1, it is possible to calculate the residual pulse cost considering the pulse energy of the pulse laser beam output from the light source LSk.

### 3. Embodiment 2

### 3.1 Configuration

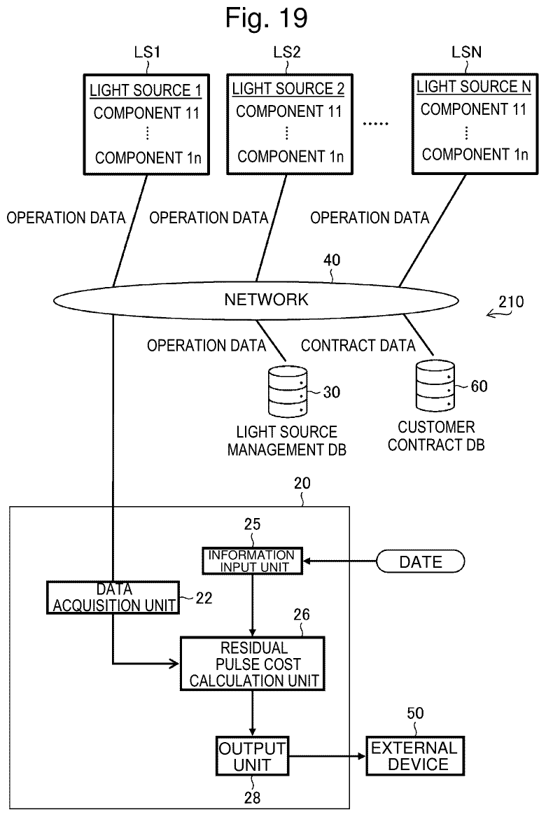

FIG. 19 schematically illustrates a configuration of a light source management system 210 according to an embodiment 2. A difference from FIG. 8 will be described with respect to FIG. 19. The light source management system 210 differs from the embodiment 1 in that the processor 20 includes an information input unit 25. The residual pulse cost calculation method in the residual pulse cost calculation unit 26 is also different from that of the embodiment 1. Other configurations may be similar to those of the embodiment 1.

The information input unit 25 is an input device such as a keyboard, a pointing device, or a voice input device. The processor 20 receives input of various kinds of information including a date via the information input unit 25. A user can designate an arbitrary date such as a current date or a future date from the information input unit 25. In addition, data such as a date may be acquired from an unillustrated plant system or the like on the network 40 via the data acquisition unit 22.

### 3.2 Operation

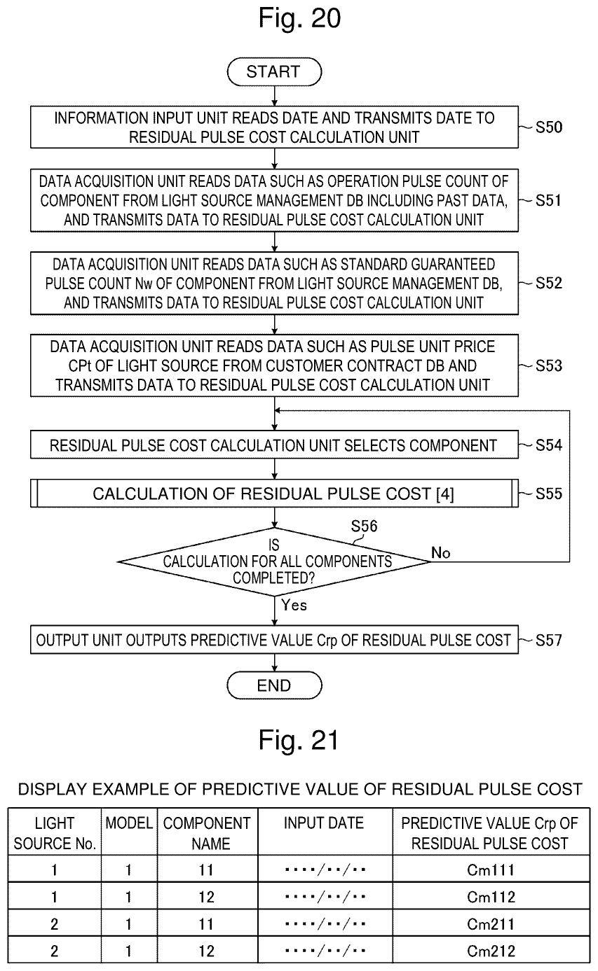

The processor 20 calculates and outputs a predictive value of the residual pulse cost of each component on the acquired date. The calculation flow is illustrated in FIG. 20.

In step S50, the information input unit 25 reads the date and transmits the date to the residual pulse cost calculation unit 26. This date may be a scheduled replacement date of the component. The scheduled replacement date may be an actual scheduled date for which a work order is received, or may be a temporary scheduled date under planning and examination.

In step S51, the data acquisition unit 22 reads data such as the operation pulse count of the component from the light source management DB 30 including the past data, and transmits the data to the residual pulse cost calculation unit 26.

Steps S52 to S54 are the same as steps S22 to S24 in FIG. 9.

In step S55, the residual pulse cost calculation unit 26 executes a subroutine of calculation [4] of the residual pulse cost. The subroutine will be described later. The residual pulse cost calculation unit 26 calculates a predictive value of the residual pulse cost by executing the subroutine of the calculation [4] of the residual pulse cost.

In step S56 after step S55, the residual pulse cost calculation unit 26 determines whether or not the calculation for all the components has been completed. When a determination result in step S56 is No determination, the residual pulse cost calculation unit 26 returns to step S54. The residual pulse cost calculation unit 26 repeats steps S54 to S56 until the calculation of the predictive value of the residual pulse cost is completed for all the components.

When the determination result in step S56 is Yes determination, the flow proceeds to step S57. In step S57, the output unit 28 outputs a predictive value Crp of the residual pulse cost. Here, “outputting” includes at least one of transmitting a calculation result to the display unit of the processor 20 and transmitting the calculation result to the display unit on the network 40 via the data acquisition unit 22. FIG. 21 illustrates a display example when displaying the predictive value Crp of the residual pulse cost on the display unit of the processor 20 or the like.

The predictive value Crp of the residual pulse cost may be calculated daily or once every few days. Further, the calculation may be performed at any time at timing of receiving an order for early component replacement.

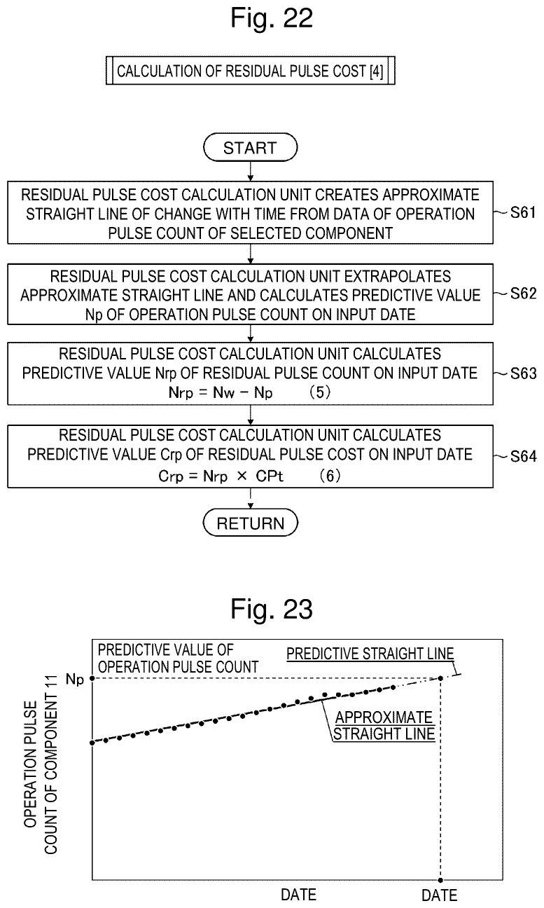

FIG. 22 is a flowchart illustrating an example of a subroutine applied in step S55 in FIG. 20.

In step S61, the residual pulse cost calculation unit 26 generates an approximate straight line of a change with time from the data of the operation pulse count of the selected component. FIG. 23 illustrates a creation example of an approximate straight line for the operation pulse count of the component 11 of the light source LS1. Since the light source management DB 30 sequentially stores the data of the operation pulse count of each component of each light source LSk together with the date, by using the time-sequential data, it is possible to create an approximate straight line of the change with time for the operation pulse count of a specific component, as illustrated in FIG. 23. Note that an approximate curve may be created instead of an approximation straight line.

In step S62, the residual pulse cost calculation unit 26 extrapolates the approximate straight line and calculates a predictive value Np of the operation pulse count on the date input from the information input unit 25. FIG. 23 illustrates an example in which a future date is designated, and the operation pulse count corresponding to the designated date is predicted from a predictive straight line obtained by extrapolating the approximate straight line.

In step S63 after step S62, the residual pulse cost calculation unit 26 calculates a predictive value Nrp of the residual pulse count on the input date for the selected component by Equation (5).

$$\\ \begin{matrix}Nrp = Nw - Np & ( 5 )\end{matrix}$$

In step S64, the residual pulse cost calculation unit 26 calculates the predictive value Crp of the residual pulse cost on the input date for the selected component by Equation (6).

$$\\ \begin{matrix}Crp = Nrp \times CPt & ( 6 )\end{matrix}$$

After step S64, the residual pulse cost calculation unit 26 ends the flowchart in FIG. 22 and returns to the flowchart in FIG. 20.

### 3.3 Effect

According to the residual pulse cost calculation method executed by the processor 20 according to the embodiment 2, the same effects as those of the embodiment 1 are obtained. Further, according to the embodiment 2, it is possible to recognize the loss at the time of early component replacement in advance.

### 3.4 Modification 1

### 3.4.1 Configuration

A configuration of the light source management system 210 according to a modification 1 of the embodiment 2 may be the same as that in FIG. 19. In the modification 1 of the embodiment 2, as compared with the embodiment 2, contract data acquired by the data acquisition unit 22 from the customer contract DB 60 is different. Further, a calculation formula for obtaining the predictive value of the residual pulse cost in the residual pulse cost calculation unit 26 is different.

### 3.4.2 Operation

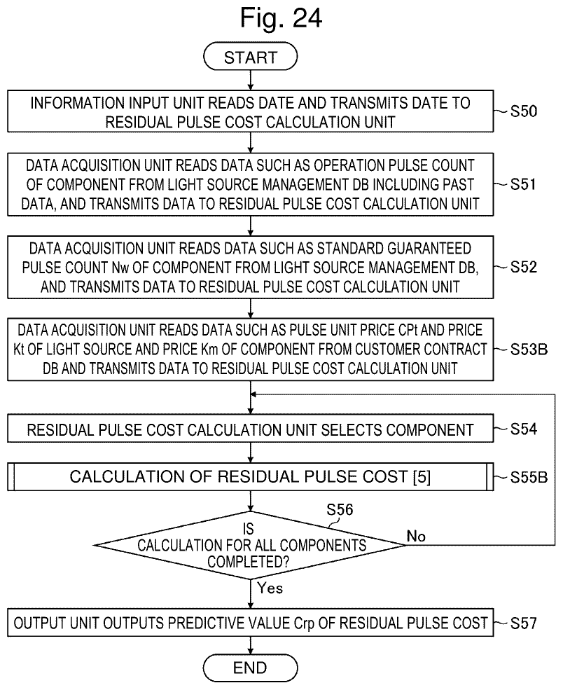

FIG. 24 is a calculation flow executed by the processor 20 according to the modification 1 of the embodiment 2. A difference from FIG. 20 will be described with respect to FIG. 24.

The flowchart in FIG. 24 includes step S53B instead of step S53 in FIG. 20, and includes step S55B instead of step S55. Step S53B is similar to step S23B in FIG. 13.

In step S55B after step S54, the residual pulse cost calculation unit 26 executes a subroutine of calculation

of the residual pulse cost. The other steps may be similar to those in FIG. 20.

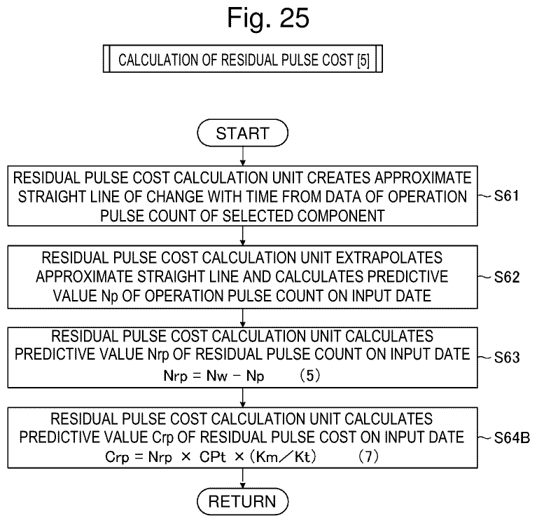

FIG. 25 is a flowchart illustrating an example of a subroutine applied to step S55B in FIG. 24. The flowchart in FIG. 25 will be described in terms of differences from that in FIG. 22.

The flowchart in FIG. 25 includes step S64B instead of step S64 in FIG. 22. The other steps may be similar to those in FIG. 22.

In step S64B after step S63, the residual pulse cost calculation unit 26 calculates the predictive value Crp of the residual pulse cost of the input date by Equation (7).

$$\\ \begin{matrix}Crp = Nrp \times CPt \times ( Km / Kt ) & ( 7 )\end{matrix}$$

After step S64B, the residual pulse cost calculation unit 26 ends the flowchart in FIG. 25 and returns to the flowchart in FIG. 24.

### 3.4.3 Effect

According to the modification 1 of the embodiment 2, the same effects as those of the embodiment 2 can be obtained. Further, according to the modification 1 of the embodiment 2, the residual pulse cost of the component is calculated using the value obtained by converting the pulse unit price CPt of the light source into the pulse unit price of the component. Therefore, it is possible to more appropriately recognize the difference in the loss depending on the components.

### 3.5 Modification 2

### 3.5.1 Configuration

A modification 2 of the embodiment 2 is a residual pulse cost calculation method considering the operating conditions such as the pulse energy, the power, and the spectral linewidth of the pulse laser beam output from the light source LSk. In the modification 2 of the embodiment 2, the standard guaranteed pulse count used for calculating the residual pulse cost in the residual pulse cost calculation unit 26 is different from that in the embodiment 2.

A configuration of the light source management system 210 according to the modification 2 of the embodiment 2 may be the same as that in FIG. 19.

### 3.5.2 Operation

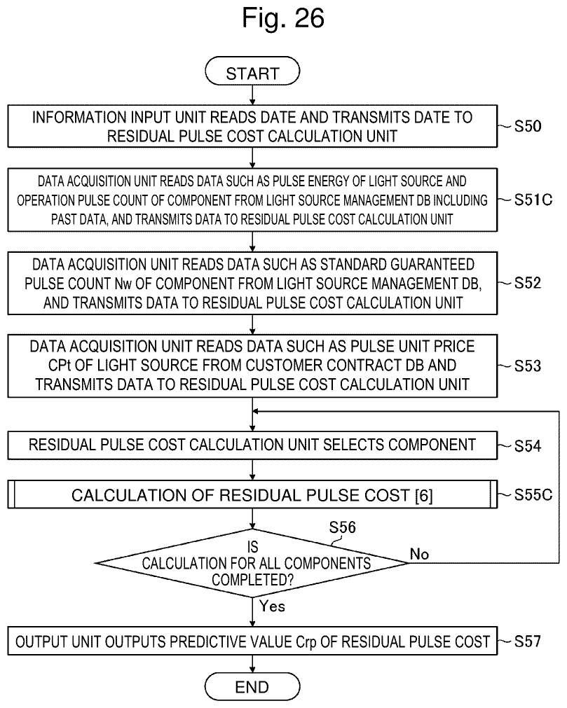

FIG. 26 is a calculation flow executed by the processor 20 according to the modification 2 of the embodiment 2. A difference from FIG. 20 will be described with respect to FIG. 26.

The flowchart in FIG. 26 includes step S55C instead of step S55 in FIG. 20. The other steps may be similar to those in FIG. 20.

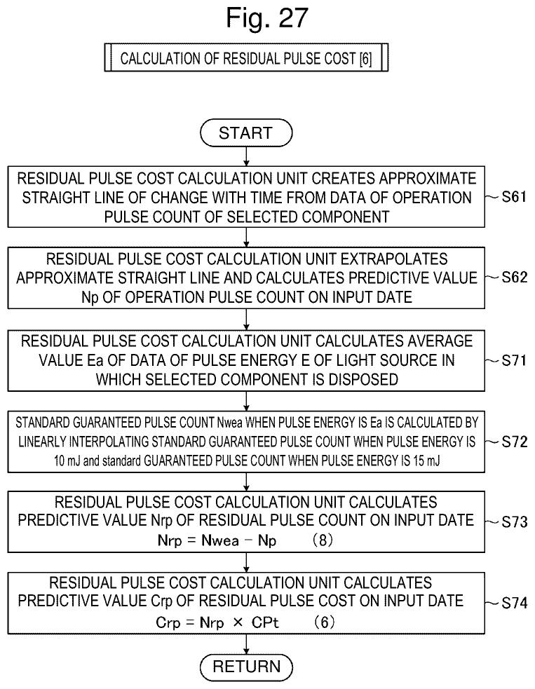

In step S55C, the residual pulse cost calculation unit 26 executes a subroutine of calculation [6] of the residual pulse cost. The subroutine is illustrated in FIG. 27.

The flowchart in FIG. 27 will be described in terms of differences from that in FIG. 22.

The flowchart in FIG. 27 includes steps S71 to S74 instead of step S63 and step S64 in FIG. 22.

Step S71 and step S72 are similar to step S41 and step S42 in FIG. 17.

In step S73 after step S72, the residual pulse cost calculation unit 26 calculates the predictive value Nrp of the residual pulse count on the input date by Equation (8).

$$\\ \begin{matrix}Nrp = Nwea - Np & ( 8 )\end{matrix}$$

Step S74 is similar to step S64 in FIG. 22. After step S64, the residual pulse cost calculation unit 26 ends the flowchart in FIG. 27 and returns to the flowchart in FIG. 26.

### 3.5.3 Effect

According to the modification 2 of the embodiment 2, the same effects as those of the embodiment 2 can be obtained. Further, according to the modification 2 of the embodiment 2, it is possible to calculate the residual pulse cost considering the pulse energy output from the light source LSk.

### 3.6 Modification 3

### 3.6.1 Configuration

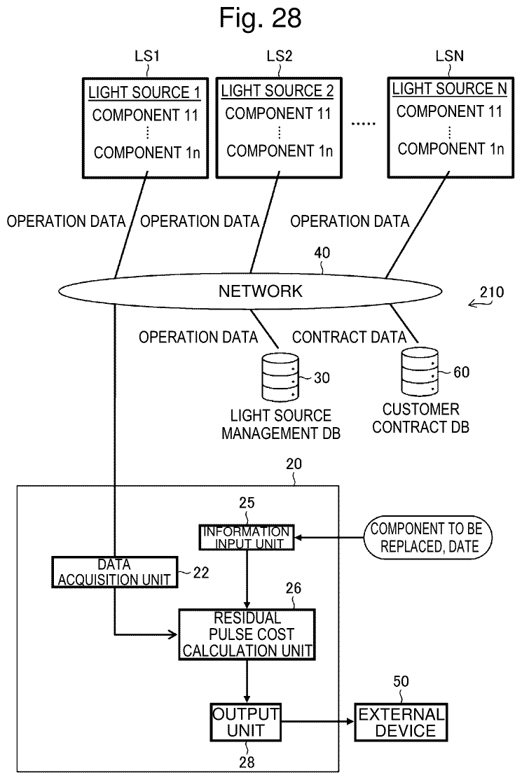

FIG. 28 schematically illustrates a configuration of the light source management system 210 according to a modification 3 of the embodiment 2. The modification 3 of the embodiment 2 differs from the embodiment 2 in that the information input unit 25 reads a component (replacement component) to be replaced and a date such as a scheduled replacement date. “The component to be replaced” means a target component for which replacement is scheduled or considered. Other configurations may be similar to those of the embodiment 2 (FIG. 19).

### 3.6.2 Operation

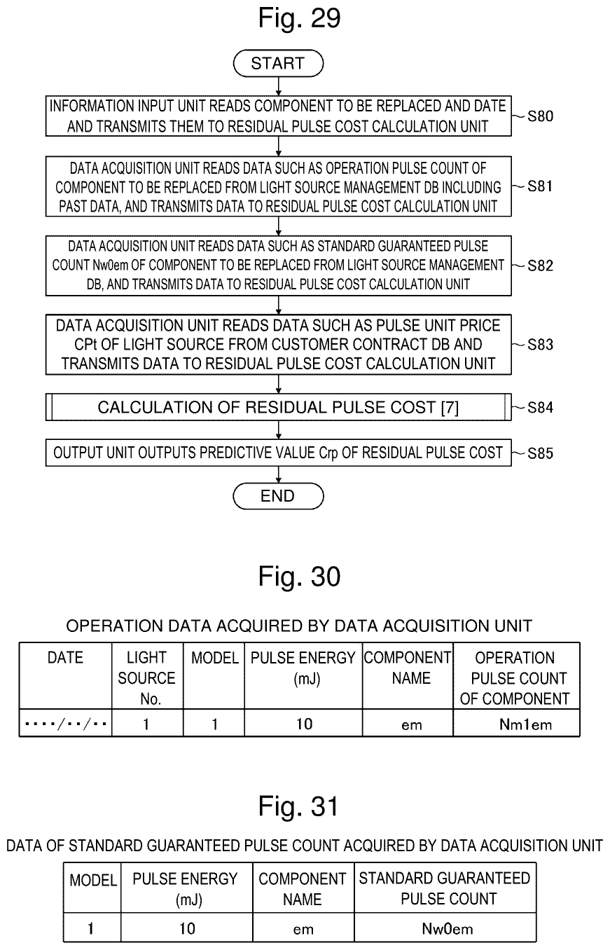

FIG. 29 is a calculation flow executed by the processor 20 according to the modification 3 of the embodiment 2. In step S80, the information input unit 25 reads the component to be replaced and the date, and transmits them to the residual pulse cost calculation unit 26. The date may be the scheduled replacement date for the component to be replaced.

In step S81, the data acquisition unit 22 reads data such as the operation pulse count of the component to be replaced from the light source management DB 30 including the past data, and transmits the data to the residual pulse cost calculation unit 26. FIG. 30 illustrates an example of the operation data acquired by the data acquisition unit 22. The operation data acquired by the data acquisition unit 22 includes data such as the date, the light source number, the model, the pulse energy, the component name, and the operation pulse count of the component.

In step S82, the data acquisition unit 22 reads data such as a standard guaranteed pulse count NwOem of the component to be replaced from the light source management DB 30, and transmits the data to the residual pulse cost calculation unit 26. FIG. 31 illustrates an example of the data of the standard guaranteed pulse count acquired by the data acquisition unit 22. FIG. 31 illustrates the example of the data in which the standard guaranteed pulse count is NwOem when the pulse energy of a model “1” is 10 mJ.

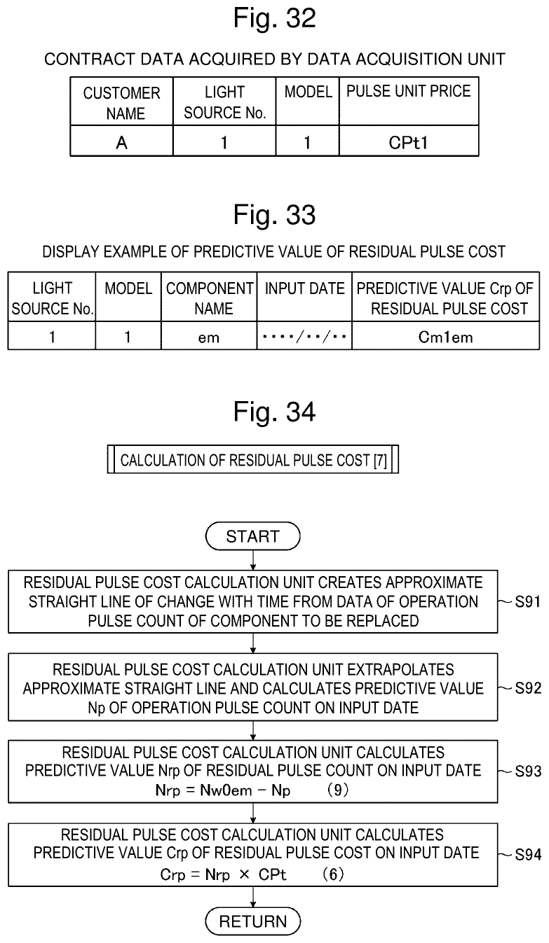

In step S83, the data acquisition unit 22 reads data such as the pulse unit price CPt of the light source in which the component to be replaced is disposed from the customer contract DB 60, and transmits the data to the residual pulse cost calculation unit 26. FIG. 32 illustrates an example of contract data acquired by the data acquisition unit 22.

In step S84, the residual pulse cost calculation unit 26 executes a subroutine of calculation [7] of the residual pulse cost. The subroutine applied to step S84 will be described later (FIG. 34). The residual pulse cost calculation unit 26 calculates the predictive value Crp of the residual pulse cost by executing the subroutine of the calculation [7] of the residual pulse cost.

In step S85, the output unit 28 outputs the predictive value Crp of the residual pulse cost. The predictive value Crp of the residual pulse cost may be calculated daily or once every few days. The processor 20 can calculate the predictive value Crp of the residual pulse cost at appropriate timing every time the information on the component to be replaced and the date is acquired via the information input unit 25 or the data acquisition unit 22.

FIG. 33 illustrates a display example when the predictive value Crp of the residual pulse cost is output to a display unit of the processor 20 or the like. The “input date” in FIG. 33 is the date acquired through the information input unit 25 in step S80.

FIG. 34 is a flowchart illustrating an example of a subroutine applied to step S84 in FIG. 29.

In step S91, the residual pulse cost calculation unit 26 creates an approximate straight line of the change with time from the data of the operation pulse count of the component to be replaced.

In step S92, the residual pulse cost calculation unit 26 extrapolates the approximate straight line and calculates the predictive value Np of the operation pulse count on the input date.

In step S93, the residual pulse cost calculation unit 26 calculates the predictive value Nrp of the residual pulse count on the input date by Equation (9).

$$\\ \begin{matrix}Nrp = Nw 0 em - Np & ( 9 )\end{matrix}$$

In step S94, the residual pulse cost calculation unit 26 calculates the predictive value Crp of the residual pulse cost on the input date by Equation (6). For example, a value of CPt1 illustrated in FIG. 32 is used as a value of the pulse unit price CPt, and the predictive value Crp of the residual pulse cost is calculated.

After step S94, the residual pulse cost calculation unit 26 ends the flowchart in FIG. 34 and returns to the flowchart in FIG. 29. In the modification 3 of the embodiment 2, the processor 20 needs to calculate the predictive value Crp of the residual pulse cost only for the designated “component to be replaced”.

### 3.6.3 Effect

According to the modification 3 of the embodiment 2, the same effects as those of the embodiment 2 can be obtained. Further, according to the modification 3 of the embodiment 2, it is possible to quickly recognize the loss (cost) of the replacement component.

### 4. Program for Realizing Processing Functions of Processor 20

A program for causing a computer to realize some or all of processing functions of the processor 20 described in the embodiments and the modifications can be recorded in a non-transitory tangible computer-readable medium, and the program can be distributed.

Further, the program for causing a computer to realize some or all of the processing functions of the processor 20 may be incorporated in a server of a light source manufacturer or a server in a semiconductor plant, or may be incorporated in a terminal device such as a personal computer or a personal digital assistant carried by a service engineer FSE, for example. In addition, the program may be applied as Saas (Software as a Service) that is deployed in a cloud server or the like for example, accepts input of required information through a network, and returns a processing result.

### 5. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the claims should be interpreted as non-limiting terms unless clearly described. For example, terms such as “comprise”, “include”, “have”, and “contain” should not be interpreted to be exclusive of other structural elements. Further, indefinite articles “a/an” should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A residual pulse cost calculation method for a component of a light source which outputs a pulse laser beam, the method comprising, by a processor:
acquiring first data in which the component of the light source and an operation pulse count of the component sequentially stored through an operation of the light source are associated with each other;
acquiring second data in which the component and a standard guaranteed pulse count of the component are associated with each other;
acquiring third data in which the light source and a pulse unit price of the light source are associated with each other;
calculating a residual pulse count of the component from the operation pulse count and the standard guaranteed pulse count;
calculating a residual pulse cost of the component from the residual pulse count and the pulse unit price; and
outputting the residual pulse cost.

2. The residual pulse cost calculation method according to claim 1, wherein
the processor calculates the residual pulse count using the operation pulse count on a latest date of the component.

3. The residual pulse cost calculation method according to claim 1, wherein
the residual pulse count is a difference between the standard guaranteed pulse count and the operation pulse count.

4. The residual pulse cost calculation method according to claim 1, wherein
the residual pulse cost is a product of the residual pulse count and the pulse unit price.

5. The residual pulse cost calculation method according to claim 1, further comprising, by the processor,
acquiring fourth data in which the light source and a price of the light source are associated with each other and fifth data in which the component and a price of the component are associated with each other, wherein
the processor calculates the residual pulse cost from an equation below:
the residual pulse cost=the residual pulse count×the pulse unit price×(the price of the component/the price of the light source).

6. The residual pulse cost calculation method according to claim 1, further comprising, by the processor,
acquiring sixth data in which the light source and an operating condition of the light source sequentially stored through the operation of the light source are associated with each other, wherein
the standard guaranteed pulse count in the second data is associated with the operating condition of the light source, and
the processor calculates the residual pulse count using the standard guaranteed pulse count corresponding to the operating condition.

7. The residual pulse cost calculation method according to claim 6, wherein
the operating condition is pulse energy of the pulse laser beam, and
the processor obtains an energy average value which is an average value of data of the pulse energy from the sixth data, and calculates the residual pulse count using the energy average value.

8. The residual pulse cost calculation method according to claim 7, wherein
the standard guaranteed pulse count in the second data includes a first standard guaranteed pulse count in a case of first pulse energy and a second standard guaranteed pulse count in a case of second pulse energy different from the first pulse energy,
the method further comprises, by the processor, calculating a third standard guaranteed pulse count when the pulse energy is the energy average value by linear interpolation between the first standard guaranteed pulse count and the second standard guaranteed pulse count, and
the residual pulse count is calculated from a difference between the third standard guaranteed pulse count and the operation pulse count.

9. A processor that calculates a residual pulse cost of a component of a light source which outputs a pulse laser beam, the processor comprising:
a data acquisition unit configured to acquire first data in which the component of the light source and an operation pulse count of the component sequentially stored through an operation of the light source are associated with each other, second data in which the component and a standard guaranteed pulse count of the component are associated with each other, and third data in which the light source and a pulse unit price of the light source are associated with each other;
a residual pulse cost calculation unit configured to calculate a residual pulse count of the component from the operation pulse count and the standard guaranteed pulse count and calculate a residual pulse cost of the component from the residual pulse count and the pulse unit price; and
an output unit configured to output the residual pulse cost.

10. A residual pulse cost calculation method for a component of a light source which outputs a pulse laser beam, the method comprising, by a processor:
acquiring first data in which the component of the light source and an operation pulse count of the component sequentially stored through an operation of the light source are associated with each other;
acquiring second data in which the component and a standard guaranteed pulse count of the component are associated with each other;
acquiring third data in which the light source and a pulse unit price of the light source are associated with each other;
acquiring a date indicating a scheduled replacement date of the component;
calculating a predictive value of the operation pulse count of the component on the date from a change with time of the operation pulse count;
calculating a predictive value of the residual pulse count of the component from the predictive value of the operation pulse count and the standard guaranteed pulse count;
calculating a predictive value of a residual pulse cost of the component from the predictive value of the residual pulse count and the pulse unit price; and
outputting the predictive value of the residual pulse cost.

11. The residual pulse cost calculation method according to claim 10, wherein
the processor obtains an approximate straight line indicating the change with time of the operation pulse count of the component based on the first data, and calculates a predictive value of the operation pulse count by extrapolating the approximate straight line.

12. The residual pulse cost calculation method according to claim 10, wherein
the processor obtains an approximate curve indicating the change with time of the operation pulse count of the component based on the first data, and calculates a predictive value of the operation pulse count by extrapolating the approximate curve.

13. The residual pulse cost calculation method according to claim 10, wherein
the processor calculates a predictive value of the residual pulse count from a difference between the standard guaranteed pulse count and a predictive value of the operation pulse count.

14. The residual pulse cost calculation method according to claim 10, wherein
the residual pulse cost is a product of the residual pulse count and the pulse unit price.

15. The residual pulse cost calculation method according to claim 10, further comprising, by a processor,
acquiring fourth data in which the light source and a price of the light source are associated with each other, and fifth data in which the component and a price of the component are associated with each other, wherein
the processor calculates a predictive value of the residual pulse cost from an equation below:
the predictive value of the residual pulse cost=the predictive value of the residual pulse count×the pulse unit price×(the price of the component/the price of the light source).

16. The residual pulse cost calculation method according to claim 10, further comprising, by a processor,
acquiring sixth data in which the light source and an operating condition of the light source sequentially stored through an operation of the light source are associated with each other, wherein
the standard guaranteed pulse count in the second data is associated with the operating condition of the light source, and
the processor calculates a predictive value of the residual pulse count using the standard guaranteed pulse count corresponding to the operating condition.

17. The residual pulse cost calculation method according to claim 16, wherein
the operating condition is pulse energy of the pulse laser beam, and
the processor obtains an energy average value which is an average value of data of the pulse energy from the sixth data, and calculates a predictive value of the residual pulse count using the energy average value.

18. The residual pulse cost calculation method according to claim 17, wherein
the standard guaranteed pulse count includes a first standard guaranteed pulse count in a case of first pulse energy and a second standard guaranteed pulse count in a case of second pulse energy different from the first pulse energy,
the method further comprises, by the processor, calculating a third standard guaranteed pulse count when the pulse energy is the energy average value by linear interpolation between the first standard guaranteed pulse count and the second standard guaranteed pulse count, and
a predictive value of the residual pulse count is calculated from a difference between the third standard guaranteed pulse count and the operation pulse count.

19. The residual pulse cost calculation method according to claim 10, further comprising, by a processor,
receiving designation of the component to be replaced, wherein
a predictive value of the residual pulse cost is calculated only for the designated component.

20. A processor that calculates a residual pulse cost of a component of a light source which outputs a pulse laser beam, the processor comprising:
a data acquisition unit configured to acquire first data in which the component of the light source and an operation pulse count of the component sequentially stored through an operation of the light source are associated with each other, second data in which the component and a standard guaranteed pulse count of the component are associated with each other, and third data in which the light source and a pulse unit price of the light source are associated with each other;
an information input unit configured to acquire a date indicating a scheduled replacement date of the component;
a residual pulse cost calculation unit configured to calculate a predictive value of the operation pulse count on the date from a change with time of the operation pulse count, calculate a predictive value of the residual pulse count of the component from the predictive value of the operation pulse count and the standard guaranteed pulse count, and calculate a predictive value of the residual pulse cost of the component from the predictive value of the residual pulse count and the pulse unit price; and
an output unit configured to output the predictive value of the residual pulse cost.
